(19) United States
(12) Patent Application Publication
(10) Pub. No.: US 2008/0083147 A1
(43) Pub. Date: Apr. 10, 2008

(54) Clip with a Writing Surface

(76) Inventor: Michael Cucurullo, Brookline, MA (US)

Correspondence Address: HAYES, SOLOWAY P.C., 175 CANAL STREET, MANCHESTER, NH, 03101, US

(21) Appl. No.: 11/772,365

(22) Filed: Jul. 2, 2007

Related U.S. Application Data
(60) Provisional application No. 60/828,135, filed on Oct. 4, 2006.

(51) Int. Cl. G09F 3/16

(52) U.S. Cl. 40/661.01; 24/11 R; 248/206.5; 40/647

(57) ABSTRACT

A clip includes a front portion having a front edge. A back portion having a back edge is hingedly attached to the front portion. The back portion and the front portion are pivotably biased to contact at a clipping region, the clipping region at least partially including the back edge and the front edge. A writing surface is integral with the front portion.

### CROSS REFERENCE TO RELATED APPLICATION

This application claims benefit of U.S. Provisional Application Ser. No. 60/828,135 filed Oct. 4, 2006, the entire disclosure of which is incorporated herein by reference.

### FIELD OF THE INVENTION

The present invention is generally related to a clip and, more specifically, to a clip with a writing surface.

### BACKGROUND OF THE INVENTION

Currently, a number of clips or clamping devices can be found that are used for the purposes of clipping bags containing chips, pretzels and similar snack food items in a closed state after such bags have been opened. One such clipping device includes a pair of jaw members biased into abutting contact with each other, thus maintaining the bag in a closed state when the open end is inserted at the end of a bag.

Additionally, a number of clips for holding papers currently exist. Some of these clips contain magnet portions for attaching the clips to a refrigerator, or the like.

Known prior art references for clips included U.S. Pat. No. 4,656,607; 5,305,500; 6,740,233; 5,223,010; 3,939,533.

While these devices fulfill their respective, particular objectives and requirements, the aforementioned patents do not disclose a new clip with a writing surface.

Thus, a heretofore unaddressed need exists in the industry to address the aforementioned deficiencies and inadequacies.

### SUMMARY OF THE INVENTION

Embodiments of the present invention provide a clip and method for providing a clip. Briefly described, in architecture, one embodiment of the invention, among others, can be implemented as follows. The clip includes a front portion having a first writing surface. A back portion hingedly connects to the front portion. The front portion and the back portion pivotably biased to contact at a clipping region.

The present invention can also be viewed as providing methods for providing a clip with a label. In this regard, one embodiment of such a method, among others, can be broadly summarized by the following steps: pivoting a front portion and a back portion to an open position, wherein the front portion and back portion are pivotably biased to contact at a clipping region; placing the item within the clipping region; clipping the item in the clipping region between the front portion and the back portion, providing a writing surface on the front portion, and writing on the writing surface.

Other devices, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front perspective view of a clip, in accordance with a first exemplary embodiment of the present invention.

FIG. 2 is a side view of the clip of FIG. 1, in accordance with the first exemplary embodiment of the present invention.

FIG. 3 is a back view of the clip of FIG. 1, in accordance with the first exemplary embodiment of the present invention.

FIG. 4 is side view of a clip, in accordance with a second exemplary embodiment of the present invention.

FIG. 5 is a flowchart 300 illustrating a method of using the clip in accordance with the first exemplary embodiment of the invention.

### DETAILED DESCRIPTION

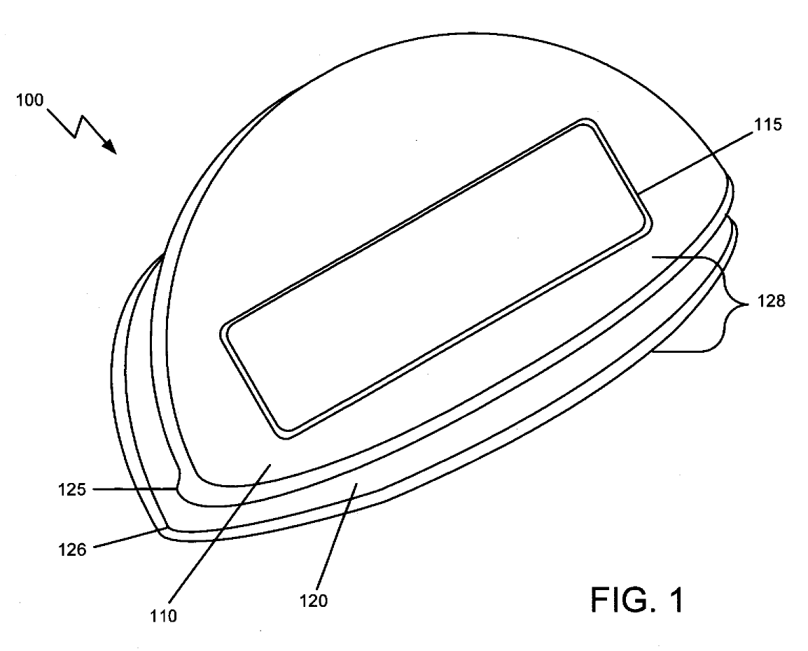

FIG. 1 is a front perspective view of a clip 100, in accordance with a first exemplary embodiment of the present invention. The clip 100 includes a front portion 110. A back portion 120 is hingedly connected to the front portion 110. In this embodiment, the front portion 110 and the back portion 120 are pivotably biased to contact at a clipping region 128. A back portion 120 has a back edge 126 that is pivotably biased to contact a lip portion 125 of front portion 110 in the clipping region.

A first writing surface 115 is integral with the front portion 110 in the first exemplary embodiment. The first writing surface 115 can be used for writing a label on a clip 100. For instance, the clip 100 may be placed on a bag, such as a bag of potato chips or pretzels and a date the bag was opened could be written on the first writing surface 115. Additionally, the clip 100 may be used for holding papers. The first writing surface 115 may be a dry erase surface or a surface for receiving removable labels, such as sticky notes. The first writing surface 115 may be used to label the material held in the clip 100. If the material is a food item, the first writing surface 115 may be labeled with information regarding the date the material was opened or may expire.

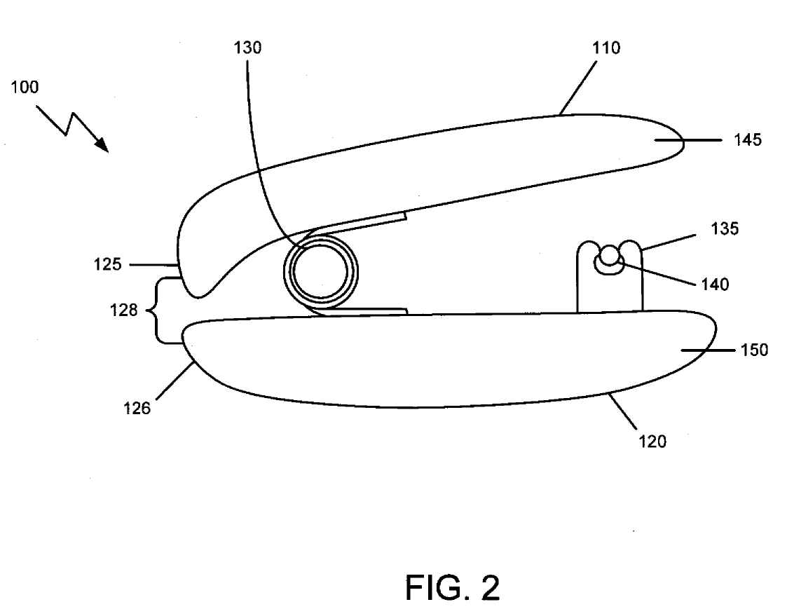

FIG. 2 is a side view of the clip 100 of FIG. 1, in accordance with the first exemplary embodiment of the present invention. The clip 100 includes a front portion 110 having a lip portion 125. A back portion 120 is shown having a back edge 126. The front portion 110 is hingedly connected to the back portion 120 through hinge mechanism 130. The lip portion 125 and the back edge 126 are pivotably biased at a clipping region 128 for securely holding a desired item such as a bag or a paper.

A protrusion 135 is provided in the first exemplary embodiment for holding a writing utensil 140. The writing utensil 140 may be a dry erase marker, with an eraser attached thereto. A pencil may also be used as a writing utensil in accordance with the first exemplary embodiment. Those having ordinary skill in the art will recognize other means exist for retaining a writing instrument 140 on the clip 100 and those means will be considered to be within the scope of the present invention. The clip 100 may similarly support an eraser if the first writing surface 115 is a dry erase board. Also, an eraser for a dry erase board may be fixed to or attachable to the writing utensil 140.

The hinge mechanism 130 in accordance with the first exemplary embodiment may be any type of hinge mechanism known to those skilled in the art. For instance, the hinge mechanism 130 may be a spring, wherein the clipping portion 128 is opened by placing a pinching pressure on a front distal end 145 and a back distal end 150. The hinge mechanism 130 in the first exemplary embodiment holds the clipping region 128 in a naturally closed position absent pressure on the front distal end 145 and the back distal end 150 to securely hold a desired material in the clip 100. Those having ordinary skill in the art will recognize other means exist for connecting the front portion 110 to the back portion 120 and for biasing the lip portion 125 and the back edge 126 together. Those means will be considered to be within the scope of the invention.

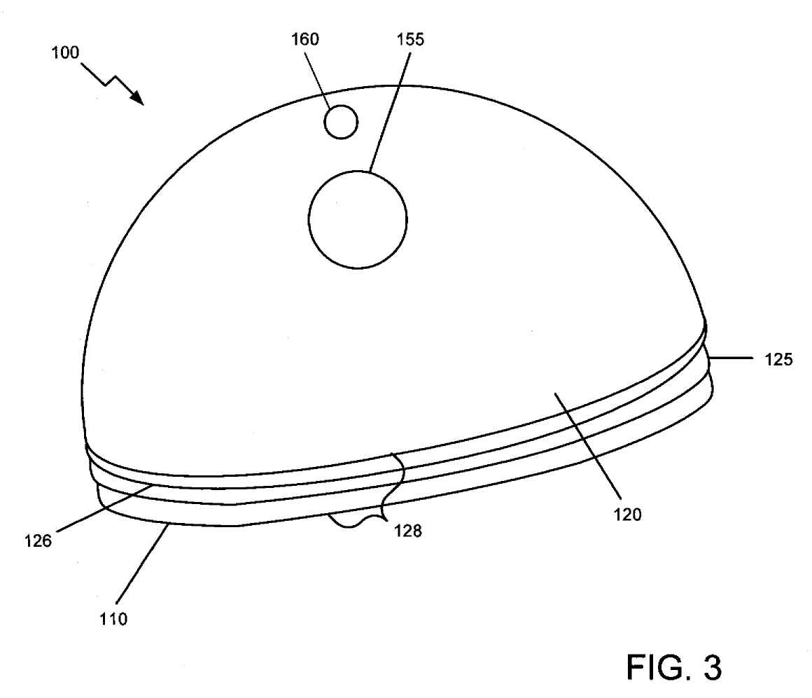

FIG. 3 is a back view of the clip 100 of FIG. 1, in accordance with the first exemplary embodiment of the present invention. The clip 100 includes a front portion 110 having a lip portion 125. A back portion 120 having a back edge 126 is hingedly attached to the front portion 110. The back portion 120 is shown with a magnet 155 for placing the clip 100 on a refrigerator or other similar surface. The magnet 155 may be any size or shape that will fit on the back portion 120, and may vary to carry different weights of paper or the like.

The back portion 120 may also include a means of allowing the back portion 120, and the clip 100 itself, to be supported along a vertical surface. The back portion 120 may further include an opening 160 from which the back portion 120 may be supported by a thumbtack or hook. Similarly, an adhesive backing may be used along the back portion 120 to support the clip 100 on a vertical surface.

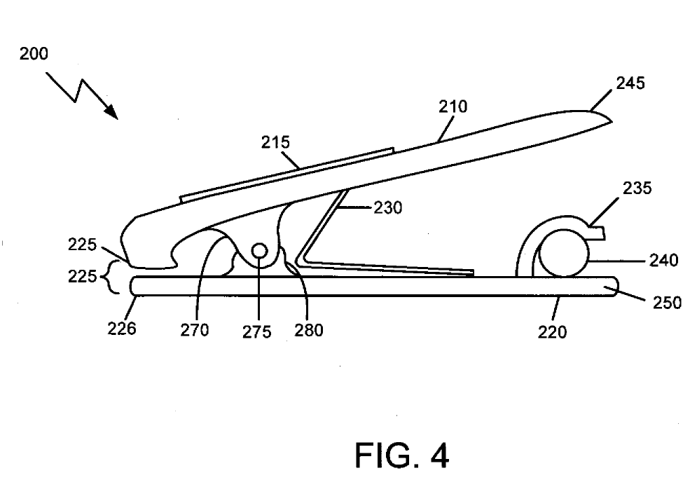

FIG. 4 is a side view of a clip 200, in accordance with a second exemplary embodiment of the present invention. The clip 200 includes a front portion 210 having a lip portion 225. A back portion 220 is shown having a back edge 226. The front portion 210 is hingedly connected to the back portion 220. More specifically, a front hinge element 270 and a back hinge element 280 are held together by a pin 275. The hinge elements 270, 280 and the pin 275 combine to provide a hinge connection between the front portion 210 and the back portion 220. While only one pair of hinge elements 270, 280 is shown, a plurality of hinge elements 270, 280 may be provided without departing from the scope of the present invention.

The lip portion 225 and the back edge 226 are pivotably biased to a closed position by a biasing mechanism 230. The biasing mechanism 230 may be a metal element. The biasing mechanism 230 is preferably axially aligned with the pin 275. The biasing mechanism 230 may operate to hold a desired item securely, such as a bag or a paper, at a clipping region 228. The clipping portion 228 may be opened by placing a pinching pressure on a front distal end 245 and a back distal end 250. The hinge mechanism 230 in the second exemplary embodiment may hold the clipping portion 128 in a naturally closed position absent pressure on the front distal end 245 and the back distal end 250 to hold a desired material in the clip 200.

A protrusion 235 is provided in the second exemplary embodiment for holding a writing utensil 240. The writing utensil 240 may be a dry erase marker, with an eraser attached thereto. A pencil may also be used as a writing utensil 240 in accordance with the second exemplary embodiment. Those having ordinary skill in the art will recognize other means exist for retaining a writing instrument 240 on the clip 200 and those means will be considered to be within the scope of the present invention. The clip 200 may similarly support an eraser if the first writing surface 215 is a dry erase board. Also, an eraser for a dry erase board may be fixed to or attachable to the writing utensil 240.

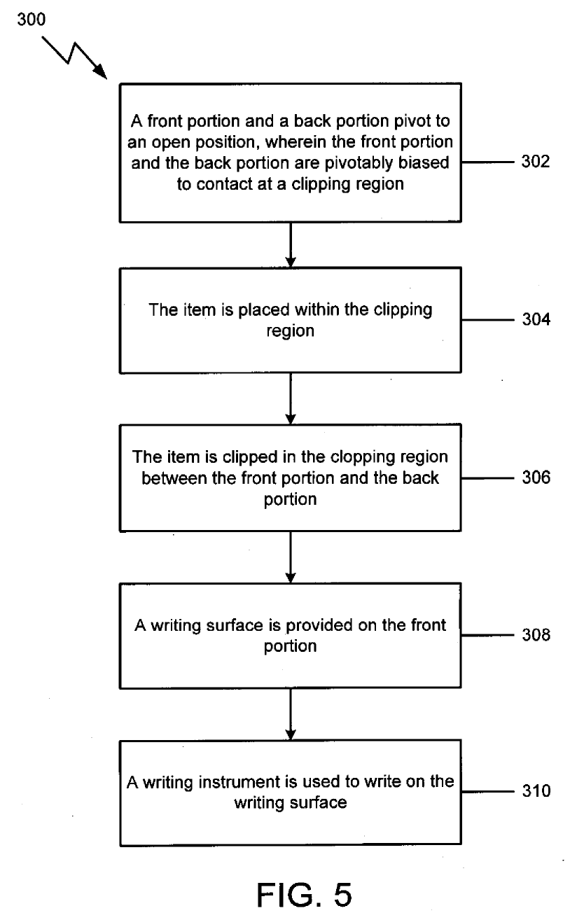

FIG. 5 is a flowchart 300 illustrating a method of using the clip 100 of FIG. 1 to hold an item, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 302, a front portion and a back portion pivot to an open position, wherein the front portion and back portion are pivotably biased to contact at a clipping region. The item is placed within the clipping region (block 304). The item is clipped in the clipping region between the front portion and the back portion (block 306). A writing surface is provided on the front portion (block 308). A writing instrument is used to write on the writing surface (block 310).

According to the method described, a user may write a note indicating types of material, due dates, expirations dated, and types of food products as reminder notes in accordance with the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A clip, comprising:
a front portion having a first writing surface; and
a back portion hingedly connected to the front portion, wherein the front portion and the back portion are pivotably biased to contact at a clipping region.

2. The clip in accordance with claim 1 further comprising at least one protrusion adapted to engage a writing utensil.

3. The clip in accordance with claim 1 further comprising a writing utensil engageable with at least one of the front portion and the back portion.

4. The clip in accordance with claim 3 wherein said writing utensil is an erasable marker.

5. The clip in accordance with claim 3 further comprising an eraser engageable with the writing utensil.

6. The clip in accordance with claim 1 further comprising at least one magnet attached to the back portion.

7. The clip in accordance with claim 1 further comprising an opening for receiving a hook formed in the back portion.

8. The clip in accordance with claim 1 wherein the front portion further comprises a lip portion at the clipping region.

9. The clip in accordance with claim 9 wherein the back portion further comprises a back lip at the clipping region.

10. The clip in accordance with claim 1, further comprising a plurality of pivoting connections between the front portion and the back portion and a metal element biasing the front portion and the back portion to contact at a clipping region.

11. A method for labeling an item, the method comprising the steps of:
pivoting a front portion and a back portion to an open position, wherein the front portion and back portion are pivotably biased to contact at a clipping region;
placing the item within the clipping region;
clipping the item in the clipping region between the front portion and the back portion,
providing a writing surface on the front portion; and
writing on the writing surface.

12. The method in accordance with claim 11 further comprising the step of hanging the back portion on a metal surface using a magnet integral with the back portion.

13. The method in accordance with claim 11 further comprising the step of engaging a writing utensil with at least one of the front portion and the rear portion.

14. The method in accordance with claim 13 further comprising the step of writing a note using the writing utensil.

15. The method in accordance with claim 14 further comprising the step of storing the writing utensil in the one or more protrusions.
